(19) United States
(12) Patent Application Publication
(10) Pub. No.: US 2024/0077895 A1
(43) Pub. Date: Mar. 7, 2024

(54) METHOD TO OPTIMISE HEAT INTEGRATION IN INDUSTRY

(71) Applicant: MCKINSEY & COMPANY, INC., New York, NY (US)

(72) Inventors: Ken Somers, New York, NY (US); Simon Barres, New York, NY (US); Jerome Sans, New York, NY (US); Cyril Verluise, New York, NY (US)

(21) Appl. No.: 18/458,759

(22) Filed: Aug. 30, 2023

Related U.S. Application Data
(60) Provisional application No. 63/403,223, filed on Sep. 1, 2022.

(51) Int. Cl. G05D 23/19

(52) U.S. Cl. CPC G05D 23/1917

(57) ABSTRACT

A method is provided for determining an approximate global optimum allotment of a plurality of devices to incorporate cold-to-hot thermal connection technologies within a plant. A computing system is provided for determining an approximate global optimum allotment of a plurality of devices to incorporate cold-to-hot thermal connection technologies within a plant. A non-transitory computer-readable storage medium is provided including executable instructions that, when executed by a processor, cause a computer to: receive, via one or more processors, device data including available heat sources, available thermal connections, and available heat sinks; process, via one or more processors, the device data to generate a twin model corresponding to the devices; generate, via one or more processors, a sequence of simulated installations based on the twin model, to approximate the global optimum allotment of the plurality of devices with respect to a plant optimization target; and cause, via one or more processors, the approximate global optimum allotment to be stored in a non-transitory computer-readable memory.

### CROSS-REFERENCE TO RELATED APPLICATIONS

This application claims priority to and the benefit of the filing date of provisional U.S. Patent Application No. 63/403,223, entitled “METHOD TO OPTIMISE HEAT INTEGRATION IN INDUSTRY,” filed on Sep. 1, 2022, the entire contents of which is hereby expressly incorporated herein by reference.

### FIELD OF THE DISCLOSURE

The present disclosure is generally directed to heat optimization within a plant and, more specifically, to methods and systems for determining an approximate global optimum allotment of a plurality of devices to incorporate cold-to-hot thermal connection technologies within a plant.

### BACKGROUND

Waste heat occurs in almost all thermal and mechanical processes. Sources of waste heat (i.e., heat sources) within a plant often include hot combustion gases discharged to the atmosphere, heated water released into the environment, heated products exiting industrial processes, heat transfer from hot equipment surfaces, etc. Estimates indicate that as much as 20 to 50 percent of industrial energy consumption is ultimately discharged as waste heat, and that between 18 and 30 percent of this waste heat could be utilized. Determining economically feasible uses for waste heat is challenging at best.

As a number of devices (e.g., heat sources, heat sinks, thermal connection technologies, etc.) within a plant increases, determining a global optimum allotment of the plurality of devices becomes, at best, computationally impracticle. In lieu of attempting to determine an actual global optiumum allotment, pinch analysis has been used to determine an approximate global optimum allotment of a plurality devices that include hot-to-cold thermal connection technologies for waste heat recovery along with using net present value as a plant optimization target.

Thus, there is a need for improved techniques to determine an approximate global optimum allotment of a plurality of devices to incorporate cold-to-hot thermal connection technologies within a plant in addition to, or in lieu of hot-to-cold thermal connection technologies. There is a further need for improved techniques to determine an approximate global optimum allotment of a plurality of devices to consider plant optimization targets in addition to, or other than net present value.

### BRIEF SUMMARY

In one aspect, a computer-implemented method for determining an approximate global optimum allotment of a plurality of devices to incorporate cold-to-hot thermal connection technologies within a plant may include receiving, via one or more processors, device data including available heat sources, available thermal connections, and available heat sinks. The method may also include processing, via one or more processors, the device data to generate a twin model corresponding to the devices. The method may further include generating, via one or more processors, a sequence of simulated installations based on the twin model, to approximate the global optimum allotment of the plurality of devices with respect to a plant optimization target. The method may yet further include causing, via one or more processors, the approximate global optimum allotment to be stored in a non-transitory computer-readable memory.

In another aspect, a computing system for determining an approximate global optimum allotment of a plurality of devices to incorporate cold-to-hot thermal connection technologies within a plant may include one or more processors and a memory comprising instructions that, when executed, cause the computing system to receive, via one or more processors, device data including available heat sources, available thermal connections, and available heat sinks. Further execution of the instructions may further cause the computing system to process, via one or more processors, the device data to generate a twin model corresponding to the devices. Even further execution of the instructions may even further cause the computing system to generate, via one or more processors, a sequence of simulated installations based on the twin model, to approximate the global optimum allotment of the plurality of devices with respect to a plant optimization target. Yet further execution of the instructions may yet further cause the computing system to cause, via one or more processors, the approximate global optimum allotment to be stored in a non-transitory computer-readable memory.

In yet another aspect, a non-transitory computer-readable storage medium comprising executable instructions that, when executed by a processor, cause a computer to receive, via one or more processors, device data including available heat sources, available thermal connections, and available heat sinks. Further execution of the instructions may further cause the computer to process, via one or more processors, the device data to generate a twin model corresponding to the devices. Even further execution of the instructions may even further cause the computer to generate, via one or more processors, a sequence of simulated installations based on the twin model, to approximate the global optimum allotment of the plurality of devices with respect to a plant optimization target. Yet further execution of the instructions may yet further cause the computer to cause, via one or more processors, the approximate global optimum allotment to be stored in a non-transitory computer-readable memory.

### BRIEF DESCRIPTION OF THE DRAWINGS

The figures described below depict various aspects of the system and methods disclosed therein. It should be understood that each figure depicts one embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1A depicts a computing system for determining an approximate global optimum allotment of a plurality of devices to incorporate cold-to-hot thermal connection technologies within a plant, in accordance with various aspects discussed herein.

FIG. 1B depicts an exemplary block diagram depicting a computing device for determining an approximate global optimum allotment of a plurality of devices to incorporate cold-to-hot thermal connection technologies within a plant, according to some aspects.

FIG. 1C depicts an exemplary block flow diagram of a computer-implemented method for determining an approximate global optimum allotment of a plurality of devices to incorporate cold-to-hot thermal connection technologies within a plant, according to some aspects.

FIG. 2A depicts an exemplary chemical plant with distillation column, reboiler, and condenser;

FIG. 2B depicts an exemplary plant including various heat sources, heat sinks, and thermal connections, according to some aspects.

FIG. 3 depicts an exemplary user interface for determining an approximate global optimum allotment of a plurality of devices to incorporate cold-to-hot thermal connection technologies within a plant, according to some aspects.

FIG. 4 depicts an exemplary source/sink mapping user interface, according to some aspects.

FIG. 5 depicts an exemplary device data input user interface, according to some aspects.

FIG. 6 depicts an exemplary block flow diagram depicting a top down allotment and a bottom up allotment, according to some aspects.

FIG. 7 depicts a flow diagram for an example top-down allotment algorithm, according to some aspects.

FIG. 8 depicts a flow diagram for an example shortsighted allotment algorithm, according to some aspects.

FIG. 9 depicts a flow diagram for an example branch-and-bound allotment algorithm, according to some aspects.

FIG. 10 depicts a flow diagram for an example beam allotment algorithm, according to some aspects.

FIG. 11 depicts an example three-dimensional allotment data cube, according to some aspects.

FIG. 12 depicts an example allotment summary display, according to some aspects.

FIG. 13 depicts an example sankey diagram of optimized waste heat recovery, according to some aspects.

### DETAILED DESCRIPTION

### Overview

The aspects described herein relate to, inter alia, techniques to determine an approximate global optimum allotment of a plurality of devices (e.g., a plurality of heat sources, a plurality of heat sinks, a plurality of thermal connections, etc.) to incorporate cold-to-hot thermal connection technologies within a plant in addition to, or in lieu of hot-to-cold thermal connection technologies. Further aspects herein relate to, inter alia, techniques to determine an approximate global optimum allotment of a plurality of devices to consider plant optimization targets (e.g., carbon dioxide CO₂ emissions, nitrogen oxides NOx emissions, sulfur dioxide SO₂ emissions, etc.) in addition to, or other than net present value (NPV).

In one exemplary embodiment, an approximate global optimum allotment identified a heat source and a heat sink within a plant that, when connected via a heat pump (i.e, a cold-to-hot thermal connection) powered via a renewable energy source (e.g., wind, solar, bio-fuel, etc.) resulted in a carbon dioxide CO₂ emission reduction (i.e., a plant optimization target) for an associated plant.

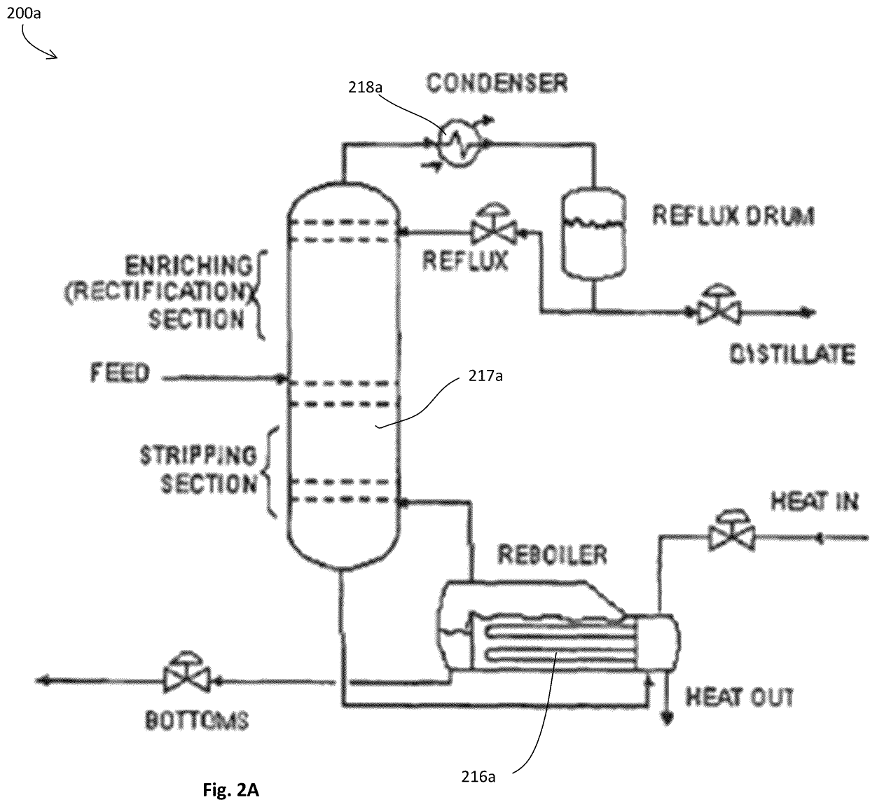

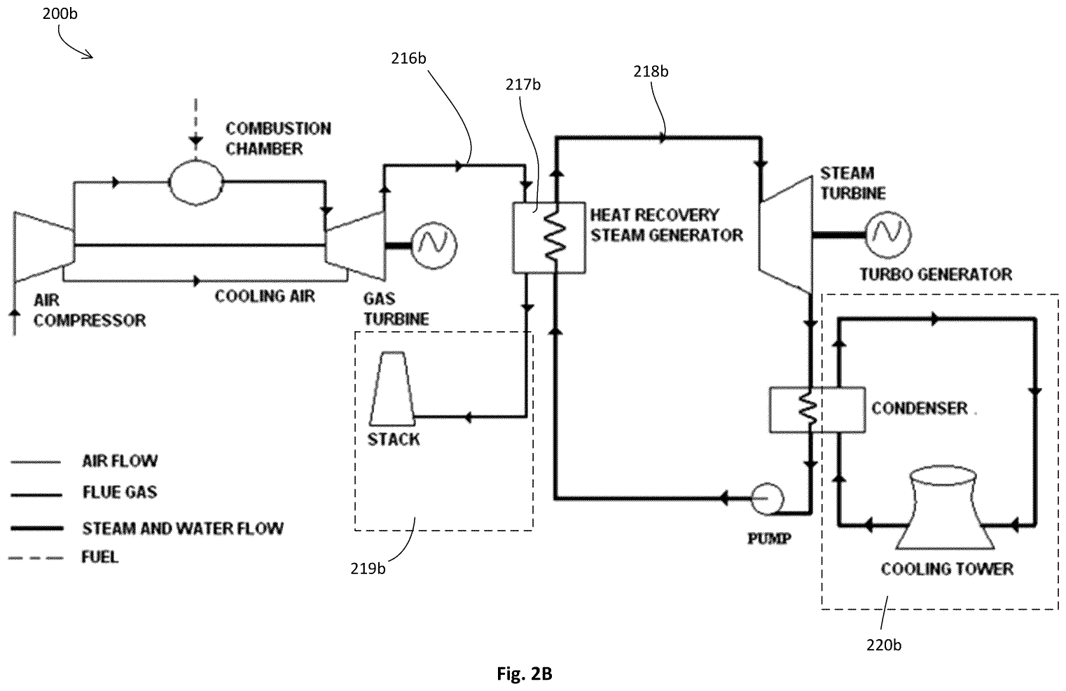

Waste heat occurs in almost all thermal and mechanical processes. Sources of waste heat (i.e., a heat source) may include, for example, hot combustion gases discharged to the atmosphere (e.g., stack 219 of FIG. 2, etc.), heated water released into the environment, heated products exiting industrial processes, and heat transfer from hot equipment surfaces. As such, waste heat sources differ regarding the aggregate state (mainly fluid and gaseous), temperature range, and frequency of their occurrence. Significant amounts of waste heat may be lost in industrial and energy generation processes. Waste heat may be released as by-product of various processes in different forms such as: combustion gases discharged to the atmosphere; heated water released into environment; heated products exiting industrial processes, and heat transfer from hot equipment surfaces. As such, waste heat sources differ regarding the aggregate state (mainly fluid and gaseous), temperature range, and frequency of their occurrence.

Some of the most typical waste heat sources and their potential for energy recovery may include: process exhaust air, cooling systems, air compression facilities, ventilation technologies, etc. Any given thermal connection (e.g., a cold-to-hot thermal connection, a hot-to-cold thermal connection, etc.) may utilize waste heat internally and/or externally with respect to a given plant or facility. Internal waste heat utilization may be configured to, for example, reintegrate the waste heat into production processes by waste heat recovery or by using it for a heat supply. Alternatively, or additionally, internal waste heat utilization may involve the waste heat transformation into other useful energy forms, such as electricity (e.g., by Organic Rankine Cycle (ORC)) or thermal cooling (by absorption and adsorption cooling plants).

Another option may include, for example, cross-company waste heat utilization, meaning that the waste heat that cannot be used internally can be used by third parties, in commercial or residential buildings for example. Key challenges for this option lie in access to reliable data to match the waste heat potential and demands, and the fact that these do not always match.

Often times, a most economically feasible utilization of waste heat (i.e., an approximate global optimum allotment) may require spatial proximity of the waste heat source and demand. Thermal connection technologies may, for example, require higher capital expenditures to utilize waste heat externally. A thermal connection may include, for example, a heat pump, mechanical vapor recompression (MVR), a Stirling engine, preheating of combustion air, a steam engine, drying/evaporation/preheating, an Organic Rankine Cycle (ORC) plant, a cooling unit, a heating unit, etc.

### Exemplary Computing Environment

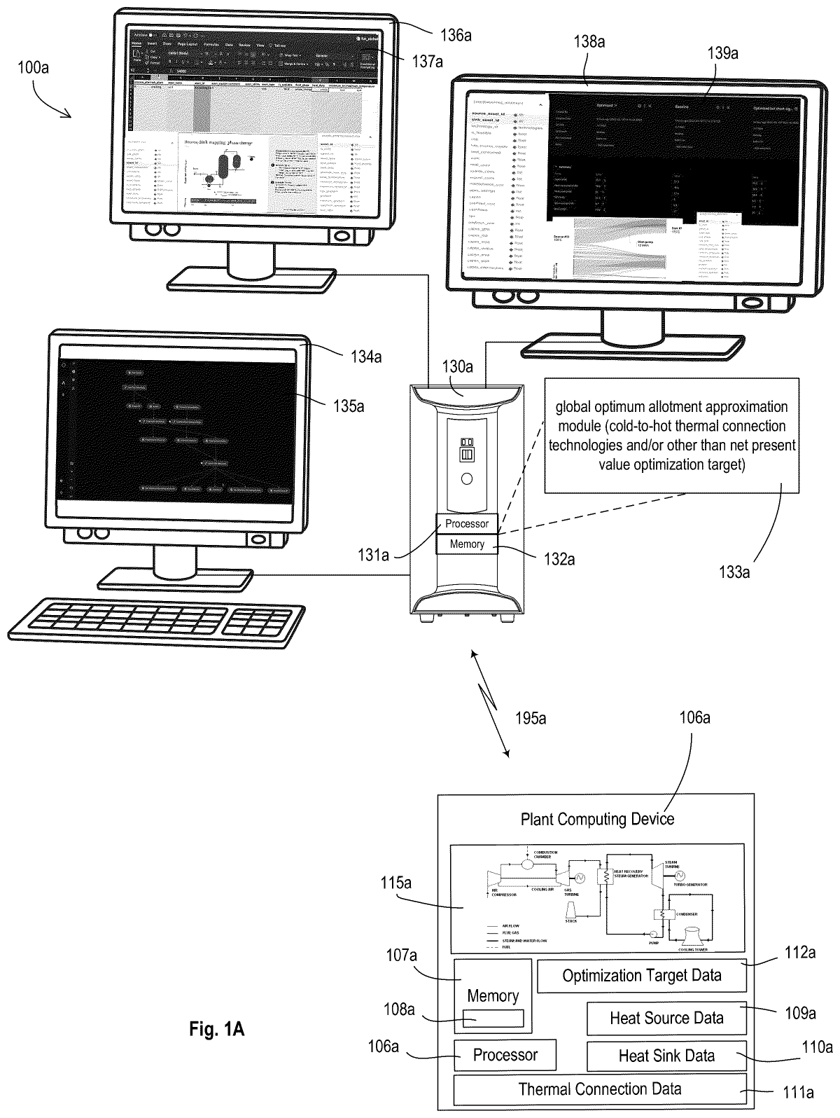

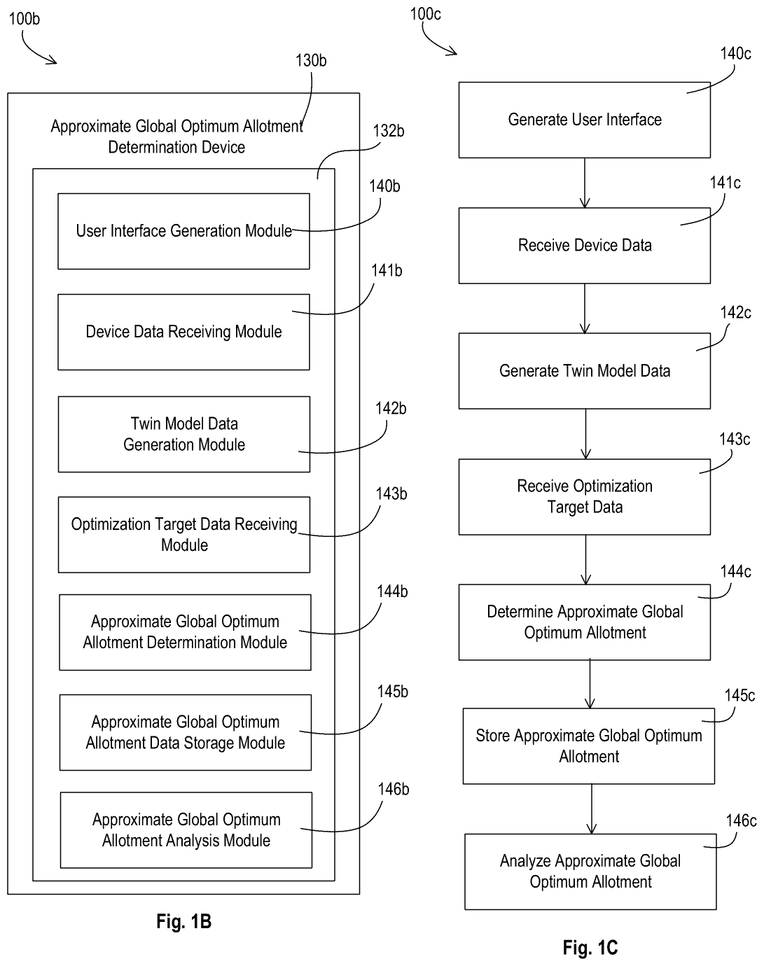

Turning to FIG. 1A, a computing system for determining an approximate global optimum allotment of a plurality of devices to incorporate cold-to-hot thermal connection technologies within a plant 100a may include a global optimum approximation device 130a communicatively connected to a plant computing device 105a via, for example, a network 195a. The plant computing device 105a may be, for example, configured to collect empirical device data (e.g., heat source data 109a, heat sink data 110a, and thermal connection data 111a from, for example, a plurality of heat sources (e.g., heat source 216b of FIG. 2B, etc.), a plurality of heat sinks (e.g., heat sink 218b of FIG. 2B, etc.), and a plurality of thermal connections (e.g., thermal connection 217b of FIG. 2B, etc.) within an operating plant (e.g., plant 200b of FIG. 2B, etc.). As an alternative, or addition, the device data may be representative of design data for a plant or a portion of the devices.

As described in detail herein, a user interface display of, for example, a display 115a, of a plant computing device 105a and/or user interface device 134a, 136a, 138a of a global optimum approximation device 130a, respectively, may be configured to enable a user to evaluate approximate global optimum allotments of a plurality of devices.

The plant computing device 105a may also include optimization target data 112a (e.g., net present value (NPV) data, carbon dioxide CO₂ emission data, etc.). The plant computing device 105a may further include a processor 106a and a non-transitory computer-readable memory 107a storing computer-readable instructions 108a that, when executed by the processor 106a may cause the plant computing device 105a to, for example, generate, transmit and/or receive heat source data 109a, heat sink data 110a, thermal connection data 111a, and optimization target data 112a with, for example, a global optimum allotment computing device 130a. The processor 106a may include one or more central processing units (CPUs), graphics processing units (GPUs), etc.

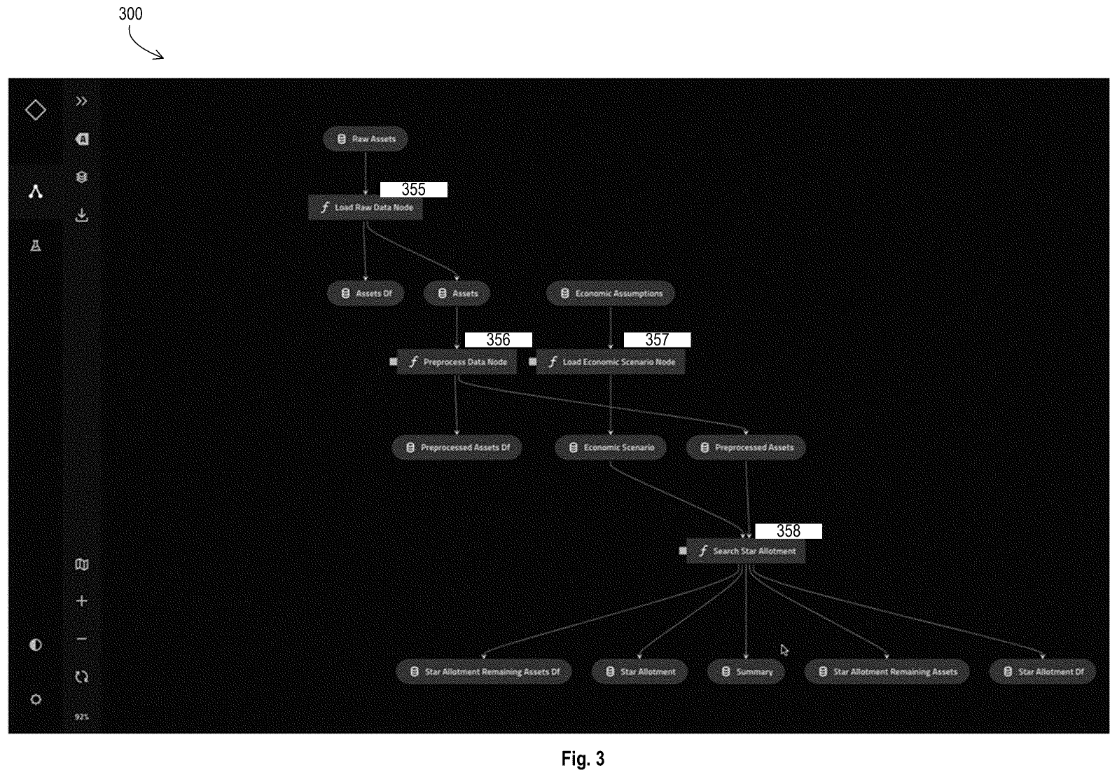

The global optimum allotment computing device 130a may include a memory 132a and a processor 131a for storing and executing, respectively, a module 133a. The module 133a, stored in the memory 132a as a set of computer-readable instructions, may be related to an application for determining an approximate global optimum allotment. The global optimum allotment computing device 130a may also include one or more user interface devices 134a, 136a, 138a which may be any type of electronic display device, such as touch screen display, a liquid crystal display (LCD), a light emitting diode (LED) display, a plasma display, a cathode ray tube (CRT) display, or any other type of known or suitable electronic display along with a user input device. The user interface device 134a, 136a, 138a may exhibit a user interface display (e.g., any user interface 135a, 137a, 139a of FIG. 1A, any of the displays of FIGS. 3-5, etc.) which may, for example, depict a user interface for implementation of at least a portion of the determining an approximate global optimum allotment.

The network 195a may, for example, include any wireless communication network, including for example: a wireless LAN, MAN or WAN, Wi-Fi, TLS v1.2 Wi-Fi, the Internet, or any combination thereof. Moreover, a plant computing device 105b may be communicatively connected to any other device via any suitable communication system, such as via any publicly available or privately owned communication network, including those that use wireless communication structures, such as wireless communication networks, including for example, wireless LANs and WANs, satellite and cellular telephone communication systems, etc.

As described in detail herein, the processor 131a may further execute the module 133a to, among other things, cause the processor 131a to receive, generate, and/or transmit data with the network 195a and the plant computing device 105a.

With reference to FIG. 1B, a computing system for determining an approximate global optimum allotment of a plurality of devices to incorporate cold-to-hot thermal connection technologies within a plant 100b may include global optimum allotment computing device 130a. The global optimum allotment computing device 130b may be similar to, for example, the global optimum allotment computing device 130a of FIG. 1A.

The global optimum allotment computing device 130b may, for example, include a user interface generation module 140b, a device data receiving module 141b, a twin model data generation module 142b, an optimization target data receiving module 143b, an approximate global optimum allotment determination module 144b, an approximate global optimum allotment data storage module 145b, and an approximate global optimum allotment analysis module 146b, for example, stored on a non-transitory computer-readable memory 132b as a set of computer-readable instructions. In any event, the modules 140b-146b may be similar to, for example, the module 133a of FIG. 1A.

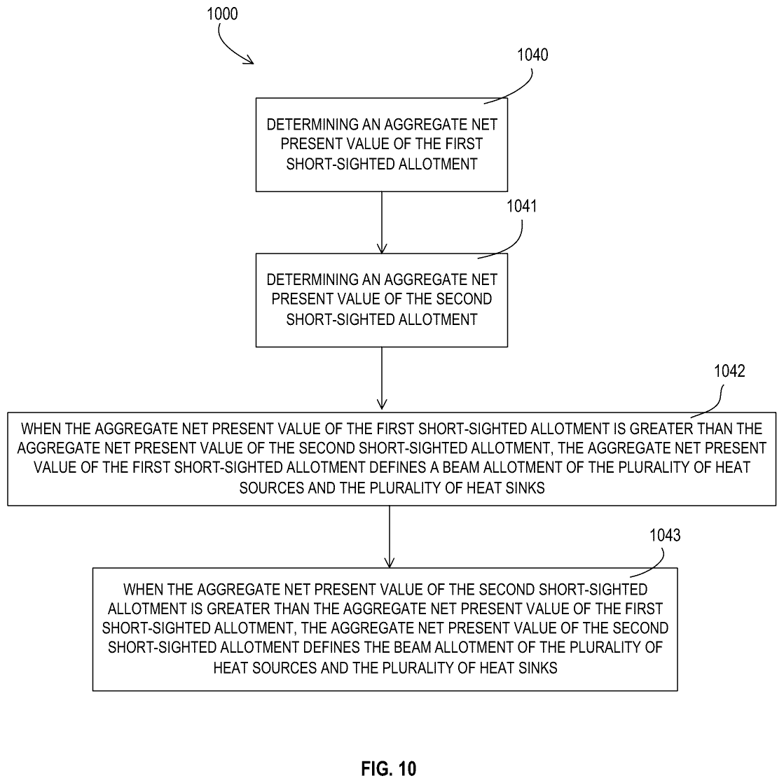

Turning to FIG. 10, a computer-implemented method for determining an approximate global optimum allotment of a plurality of devices to incorporate cold-to-hot thermal connection technologies within a plant 100c may be implemented by a processor (e.g., processor 131a of FIG. 1A) executing, for example, at least a portion of the module 133a of FIG. 1A or, at least a portion of the modules 140b-146b of FIG. 1B. In particular, processor 131a may execute the user interface generation module 140b to cause the processor 131a to, for example, generate a user interface display (block 140c). Any given user interface display may, for example, enable an individual to, for example, determining an approximate global optimum allotment of a plurality of devices to incorporate cold-to-hot thermal connection technologies within a plant 100c.

The model provides an optimal match of heat sources and sinks by looking “up” & “down” CapEx and OpEx improvement is a direct consequence of better energy usage

The processor 131a may execute the device data receiving module 141b to cause the processor 131a to, for example, receive device data (block 141c). For example, the global optimum allotment approximation device 130a may receive device data from the plant device 105a. The device data may include, for example, any of the entries of Table 1.

TABLE 1
raw device data

| elchalten.xlsx | ∧ |
|---|---|
| process_plant | [symbol] str |
| sub_plant | [symbol] str |
| asset_name | [symbol] str |
| asset_id | [symbol] str |
| asset_equipment | [symbol] str |
| comments | [symbol] str |
| asset_utility | [symbol] str |
| asset_type | [symbol] asset_types |
| is_available | [symbol] bool |
| fluid_phase | [symbol] fluid_phases |
| heat_duty | [symbol] float |
| minimum_temperatu . . . | [symbol] float |
| maximum_temperat . . . | [symbol] float |

The processor 131a may execute the twin model data generation module 142b to cause the processor 131a to, for example, generate twin model data (block 142c). The twin model data may be based on, for example, the device data. The twin model data may include, for example, any of the entries of Table 2.

TABLE 2
twin model data

| assets_preprocessed.xlsx | ∧ |
|---|---|
| asset_id | [symbol] str |
| is_child | [symbol] bool |
| parent_id | [symbol] str |
| asset_type | [symbol] asset_types |
| fluid_phase | [symbol] fluid_phases |
| heat_duty | [symbol] float |
| absolute_heat_duty | [symbol] float |
| base_temperature | [symbol] float |
| minimum_temperatu . . . | [symbol] float |
| maximum_temperat . . . | [symbol] float |
| has_gradient | [symbol] bool |
| gradient | [symbol] list |
| minimum_gradient | [symbol] float |
| maximum_gradient | [symbol] float |
| heat_ratio | [symbol] float |

The processor 131a may execute the optimization target data receiving module 143b to cause the processor 131a to, for example, receive optimization target data (block 143c). The optimization target data may be, for example, representative of a net present value (NPV) target, a carbon dioxide CO₂ emission target, etc.

The processor 131a may execute the approximate global optimum allotment determination module 144b to cause the processor 131a to, for example, determine an approximate global optimum allotment (block 144c). The approximate global optimum allotment may be based on, for example, the twin model data and the optimization target data. The twin model data may include, for example, any of the entries of Table 3 and/or Table 4.

TABLE 3
global optimum allotment approximation

| [star\|baseline]_allotment . . . | ∧ |
|---|---|
| source_asset_id | [symbol] str |
| sink_asset_id | [symbol] str |
| technology_id | [symbol] technologies |
| is_feasible | [symbol] bool |
| cop | [symbol] float |
| has_excess_supply | [symbol] bool |
| heat_consumed | [symbol] float |
| work | [symbol] float |
| heat_used | [symbol] float |
| exante_costs | [symbol] list |
| expost_costs | [symbol] list |
| maintenance_cost | [symbol] float |
| opex_savings | [symbol] list |
| capex | [symbol] float |
| overhaul_cost | [symbol] float |
| cashflows | [symbol] list |
| npv | [symbol] float |
| payback_year | [symbol] int |
| capex_gttd | [symbol] float |
| capex_lttd | [symbol] float |
| capex_lmtd | [symbol] float |
| capex_uvalue | [symbol] float |
| capex_area | [symbol] float |
| capex_work | [symbol] float |
| capex_intermediary . . . | [symbol] float |

TABLE 4
global optimum allotment approximation

| [star\|baseline]_allotment . . . | ∧ |
|---|---|
| asset_id | [symbol] str |
| is_child | [symbol] bool |
| parent_id | [symbol] str |
| asset_type | [symbol] asset_types |
| fluid_phase | [symbol] fluid_phases |
| heat_duty | [symbol] float |
| absolute_heat_duty | [symbol] float |
| base_temperature | [symbol] float |
| minimum_temperatu . . . | [symbol] float |
| maximum_temperat . . . | [symbol] float |
| has_gradient | [symbol] bool |
| gradient | [symbol] list |
| minimum_gradient | [symbol] float |
| maximum_gradient | [symbol] float |
| heat_ratio | [symbol] float |

The processor 131a may execute the approximate global optimum allotment data storage module 145b to cause the processor 131a to, for example, store global optimum allotment data (block 145c). The processor 131a may execute the approximate global optimum allotment analysis module 146b to cause the processor 131a to, for example, analyze global optimum allotment data (block 146c).

Any given approximate global optimum allotment may include, for example, modeling of two fundamental class of objects: Assets: assets refer to the physical elements of the plants which are in supply (source)/demand (sink) of heat, and thermal connection technologies: technologies describe the way a source and a sink can be connected (efficiency, costs, etc.).

Based on these objects, a twin model of the plant may be created, and different allotments may be evaluated. As an example, a best allotment approximation may include an “allotment” based on a sequence of installations. Each installation may be, for example, defined by a technology, a source, a sink and its relative place in the allotment process.

Various allotments may be simulated based on the twin model in order to, for example, approximate a best possible allotment. “Best” may be an allotment maximizing, for example, a sum of NPVs such that an aggregate heat demand is exhausted.

The processor 131a may execute the approximate global optimum allotment determination module 144b to cause the processor 131a to, for example, determine an approximate global optimum allotment (block 144c) that may incorporate at least one cold-to-hot thermal connection technology(ies). Alternatively, or additionally, the processor 131a may execute the approximate global optimum allotment determination module 144b to cause the processor 131a to, for example, determine an approximate global optimum allotment (block 144c) that may incorporate at least one conventional/standard hot-to-cold connection technologies (e.g. heat exchangers). For example, an approximate global optimum allotment may include a hot-to-cold thermal connection technology based on an NPV optimization target. In any event, an approximate global optimum allotment may not be restricted to either “cold-to-hot” or “hot-to-cold” thermal connection technolgies in determination of a best allotment.

Turning to FIG. 2A, a chemical plant 200a may include at least one reboiler 216a, at least one distillation column 217a, and at least one condenser 218a. While only one reboiler 216a, one distillation column 217a, and one condenser 218a, any given chemical plant may include any number of reboilers 216a, distillation columns 217a, and condensers 218a.

With reference to FIG. 2B, a plant 200b may including various heat sources 216b, 219b, 220b, heat sinks 218b, and thermal connections 217b. The plant 200b may be combined with the chemical plant 200a, or portions thereof. Steam-powered plants are pervasive within, for example, chemical plants, food (e.g., dairy, sugar, etc.) processing plants; pulp and paper processing plants, etc. Plants may waste energy in the form of heat. Recycling heat may, for example, result in less “carbon-heavy” energy needs, hence less CO 2 emissions.

Turning to FIG. 3, a user interface for determining an approximate global optimum allotment of a plurality of devices to incorporate cold-to-hot thermal connection technologies within a plant (e.g., the plant 200) may include a device data selection icon 355, a twin model data selection icon 356, a plant optimization target data selection icon 357, and an approximate global optimum allotment selection icon 358.

The user interface 300 may include, for example, an object oriented approach to generating twin models. The user interface 300 may be based on, for example, a Kedro framework.

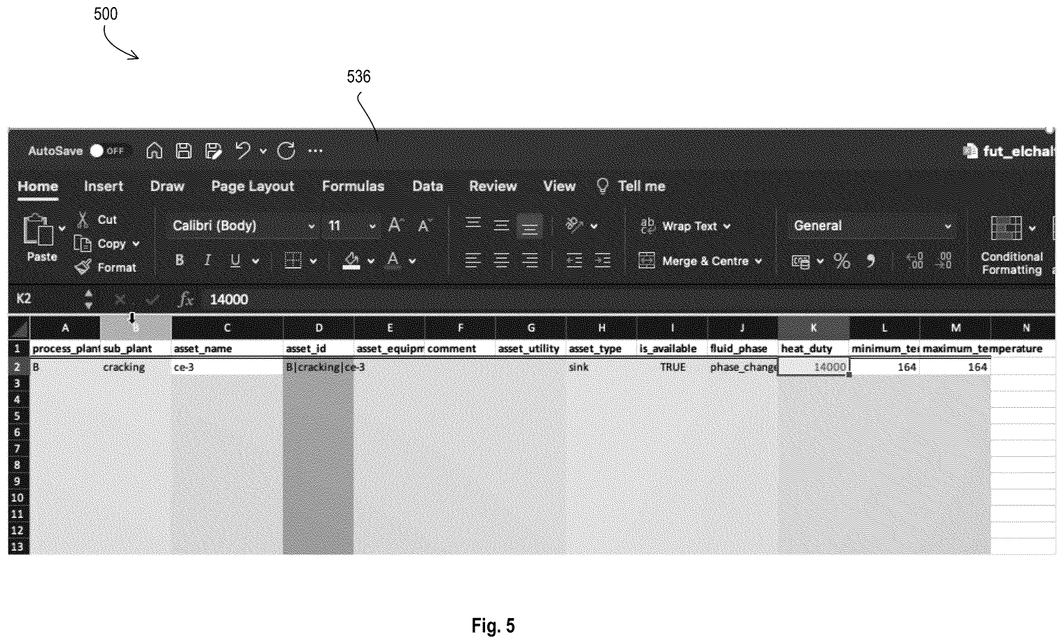

A first step to build a “digital twin” of the plant. Specifically, the focus may be on plants' assets (heat sources and sinks) and we disregard other aspects of the plants. A twin model may draw on expert based auditing of the plant's assets. Results of the audit may be reported in a latest version of the data request “template” as, for example, illustrated in user interface 500 of FIG. 5. A second step may, for example, consist in approximating a best heat recycling allotment. Note that finding the global optimum is a np hard problem, hence domain knowledge-based heuristics may be used to approximate a global optimal in a reasonable amount of time.

An “allotment” may be representative of, for example, a sequence of installations, where each installation is defined by a technology, a source, a sink and its relative place in the allotment process.

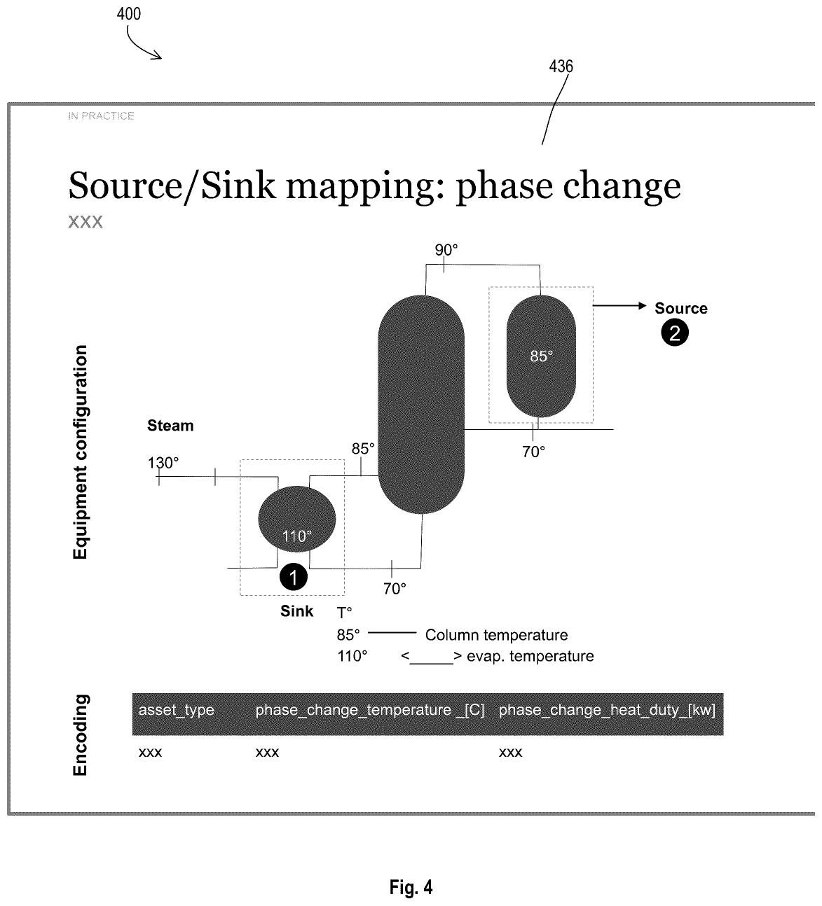

With reference to FIG. 4, a source/sink mapping user interface 400 may enable entry of a phase change temperature between a source and a sink 436, and may be determined with the minimum and maximum temperature set to a phase change temperature. A phase change temperature between a source and a sink may be depending on site constraints (e.g., a size of the reboiler cannot be increased, etc.), temperature required in a column, or temperature of a reboiler. The temperature of the steam may not be reported, nor may the temperature of condensation in the condenser. The temperature before or after the condenser may not be reported.

Turning to FIG. 5, a user interface 500 may include a device data input 536 via, for example, a spreadsheet (e.g., Microsoft Excel file, etc.). The device data input 536 may enable collection of a “template.”

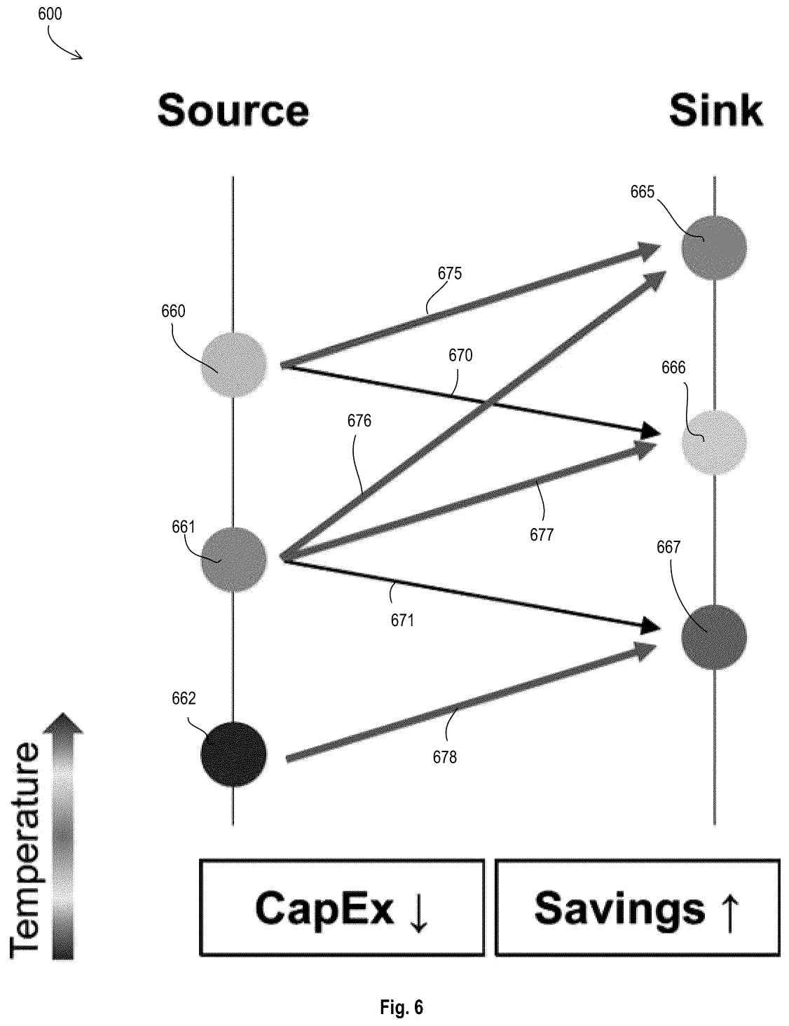

With reference to FIG. 6, a top down allotment and a bottom up allotment 600 is illustrated. The historical approach (pinch) existing plants have been built with hot-to-cold technologies 670, 671 in mind to connect wasted sources 660, 661, 662 and unmet sinks demand 665, 666, 667. Thermal connection opportunities 675, 676, 677 may include cold-to-hot, renewable electricity based technologies to increase waste heat recycling opportunities, and result in less wasted heat.

Determining an optimum global allotment is a challenge. Asymptotically, determining an approximate optimum global allotment may be, for example, similar to a dynamic traveling salesman problem in that each time a project is selected, it affects all the remaining opportunities. The approximate optimum global allotment may include, for example, a sequence of projects maximizing the sum of NPVs such that heat supply=heat demand (i.e., determining the “optimum” is a NP-hard problem). As discussed herein, the present techniques advantageously avoid O(n!) (i.e., N-factorial) runtimes that would be required for a brute force solution, and which would make the problem intractable using existing computational techniques.

Maximizing recycled heat may be accomplished using, for example, electricity based technologies, buy green electricity (e.g., Power purchase agreement, etc.), 20-40° C. ventilation systems, 30-75° C. preheating warm water, preheating for heating pumps, 40-90° C. process facilities, drying systems, cooling systems, waste water heat/cooling water, 75-125° C. service water heating, heating and warm water generation, drying (and vaporization), 80-190° C. cooling generation, 100-150° C. steam from steam generation plants, 125-275° C. production processes, drying processes, 70-450° C. waste heat utilization for generation of electricity by ORC-processes, 125-600° C. preheating of feed water or combustion air, 150-600° C. form in combustion processes, 250-540° C. waste heat utilization for generation of electricity by steam processes, etc. By electrifying waste heat recovery the waste heat recovery the decarbonization potential can be maximized. By decreasing heat needed, both CapEx and OpEx savings can be improved.

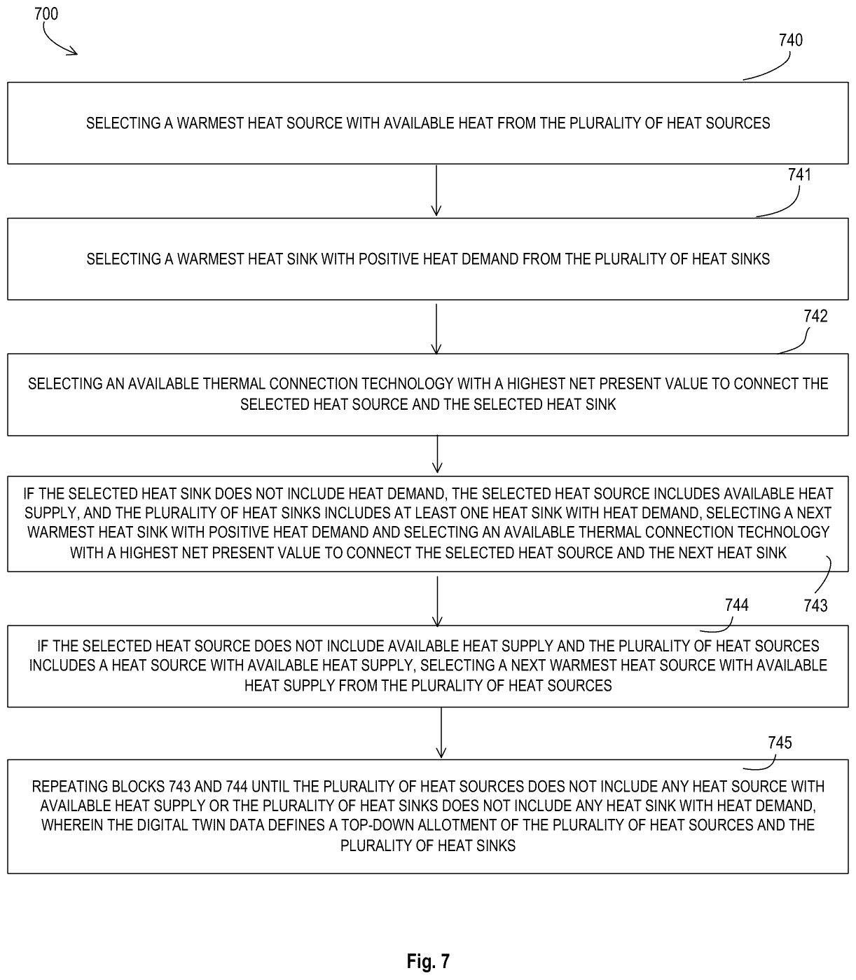

Turning to FIG. 7, a top-down allotment algorithm 700 may be implemented by a processor (e.g., processor 131a of FIG. 1A) executing, for example, at least a portion of the module 133a of FIG. 1A or, at least a portion of the modules 140b-146b of FIG. 1B. In particular, processor 131a may execute the approximate global optimum allotment determination module 144b to cause the processor 131a to, for example, selecting a warmest heat source with available heat from the plurality of heat sources (block 740).

The processor 131a may further execute the approximate global optimum allotment determination module 144b to cause the processor 131a to, for example, selecting a warmest heat sink with positive heat demand from the plurality of heat sinks (block 741). The processor 131a may further execute the approximate global optimum allotment determination module 144b to cause the processor 131a to, for example, selecting an available thermal connection technology with a highest net present value to connect the selected heat source and the selected heat sink (block 742).

The processor 131a may further execute the approximate global optimum allotment determination module 144b to cause the processor 131a to, for example, selecting a warmest heat sink with positive heat demand from the plurality of heat sinks (block 743). The processor 131a may further execute the approximate global optimum allotment determination module 144b to cause the processor 131a to, for example, if the selected heat sink does not include heat demand, the selected heat source includes available heat supply, and the plurality of heat sinks includes at least one heat sink with heat demand, selecting a next warmest heat sink with positive heat demand and selecting an available thermal connection technology with a highest net present value to connect the selected heat source and the next heat sink (block 744).

The processor 131a may further execute the approximate global optimum allotment determination module 144b to cause the processor 131a to, for example, if the selected heat source does not include available heat supply and the plurality of heat sources includes a heat source with available heat supply, repeating blocks 743 and 744 until the plurality of heat sources does not include any heat source with available heat supply or the plurality of heat sinks does not include any heat sink with heat demand, wherein the digital twin data defines a top-down allotment of the plurality of heat sources and the plurality of heat sinks (block 745).

Specifically, for every selection of a a candidate (technology(source, sink)), the heat available from/required by its source/sink changes, directly affecting the efficiency/profitability of candidates at the next round. Hence, a decision that seems optimal at a given point in time can have an overall detrimental impact of the allotment performance. In brief, each decision taken here has a shadow/opportunity cost.

In this setting, finding the global optimum is a O(n!) problem, where n represents the cardinality (i.e., size) of sources×sinks×technologies. This is intractable even for a small number of sources, sinks and technologies. Hence, the present techniques favor an approximation of the global optimum over a brute force search. Top-down approximation may, for example, use domain-related heuristics. An important insight not appreciated in the prior art is that cold-to-hot technologies (i.e. technologies which go from cold sources to hot sinks, in relative terms) are the most expensive. These technologies are all the more expensive as the temperature difference between the source and the sink increases. Therefore, the present techniques seek to minimize the temperature difference between the sources and the sinks connected by cold-to-hot technologies. One way to approximate that is the following method: 1) start from the warmest source with available heat connect it to the warmest sink with positive heat demand using the best (npv-wise) technology available, then move to the next step: 2) if the sink is exhausted and there is still heat supply in our source, turn to the next warmest sink with positive heat demand and look for the best technology to connect the source and the sink. Next, 3) if the source is exhausted, turn to the next warmest source with available heat supply. Next, 4) iterate until there is no more source with available heat supply or there is no more sink with heat demand. The present techniques refer to this resolution approach the top-down approach. The present techniques also include a so-called shortsighted resolution (which can serve as a benchmark) that includes iteratively selecting the best (npv-wise) candidate (technology(source, sink)) in the universe of sources×sinks with positive heat demand/supply each time. A short-sited allotment may be, for example, a sub-optimal situation.

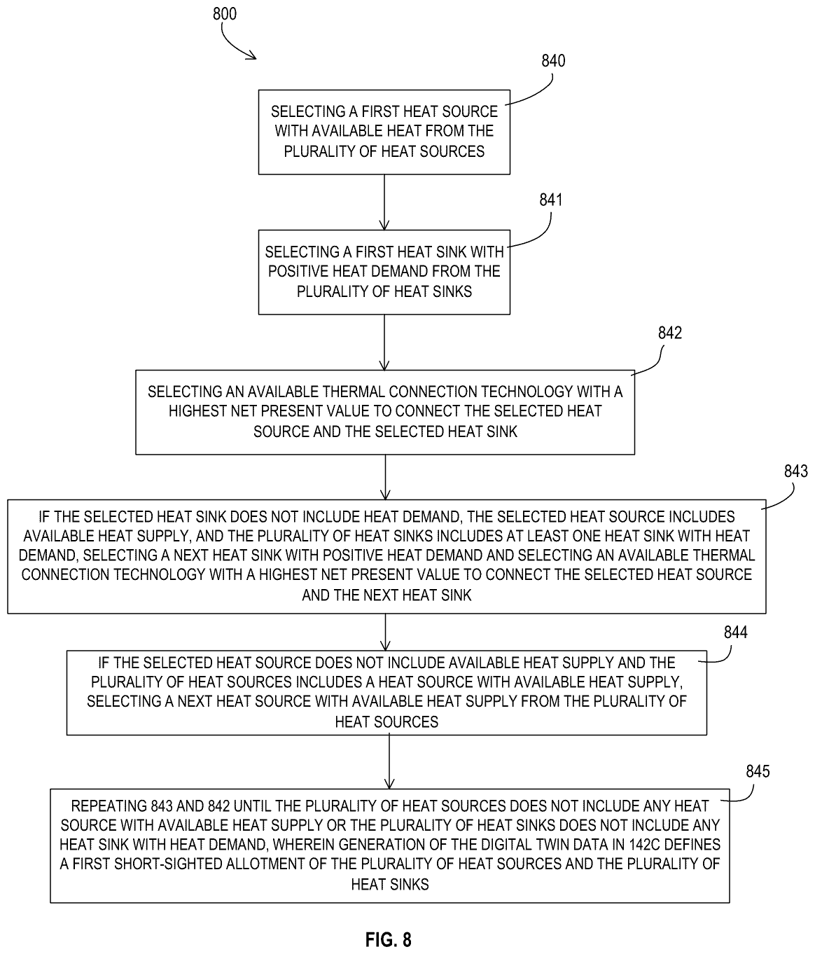

With reference to FIG. 8, a short-sighted allotment algorithm 800 may be implemented by a processor (e.g., processor 131a of FIG. 1A) executing, for example, at least a portion of the module 133a of FIG. 1A or, at least a portion of the modules 140b-146b of FIG. 1B. In particular, processor 131a may execute the approximate global optimum allotment determination module 144b to cause the processor 131a to, for example, selecting a first heat source with available heat from the plurality of heat sources (block 840).

The processor 131a may further execute the approximate global optimum allotment determination module 144b to cause the processor 131a to, for example, selecting a first heat sink with positive heat demand from the plurality of heat sinks (block 841). The processor 131a may further execute the approximate global optimum allotment determination module 144b to cause the processor 131a to, for example, selecting an available thermal connection technology with a highest net present value to connect the selected heat source and the selected heat sink (block 842).

The processor 131a may further execute the approximate global optimum allotment determination module 144b to cause the processor 131a to, for example, if the selected heat sink does not include heat demand, the selected heat source includes available heat supply, and the plurality of heat sinks includes at least one heat sink with heat demand, selecting a next heat sink with positive heat demand and selecting an available thermal connection technology with a highest net present value to connect the selected heat source and the next heat sink (block 843). The processor 131a may further execute the approximate global optimum allotment determination module 144b to cause the processor 131a to, for example, if the selected heat source does not include available heat supply and the plurality of heat sources includes a heat source with available heat supply, selecting a next heat source with available heat supply from the plurality of heat sources (block 844).

The processor 131a may further execute the approximate global optimum allotment determination module 144b to cause the processor 131a to, for example, repeating block 843 and block 842 until the plurality of heat sources does not include any heat source with available heat supply or the plurality of heat sinks does not include any heat sink with heat demand, wherein generation of the digital twin data in 142c defines a first short-sighted allotment of the plurality of heat sources and the plurality of heat sinks (block 845).

An optimization problem may be similar to, for example, a “dynamic Traveling Salesman Problem (TSP).” Like the TSP, “the rule that one first should go from the starting point to the closest [most profitable] point, then to the point closest [most profitable] to this, etc., in general does not yield the shortest [optimal] route.” Like dynamic TSP, the cost/benefit of a connection depends on the set of already selected connections.

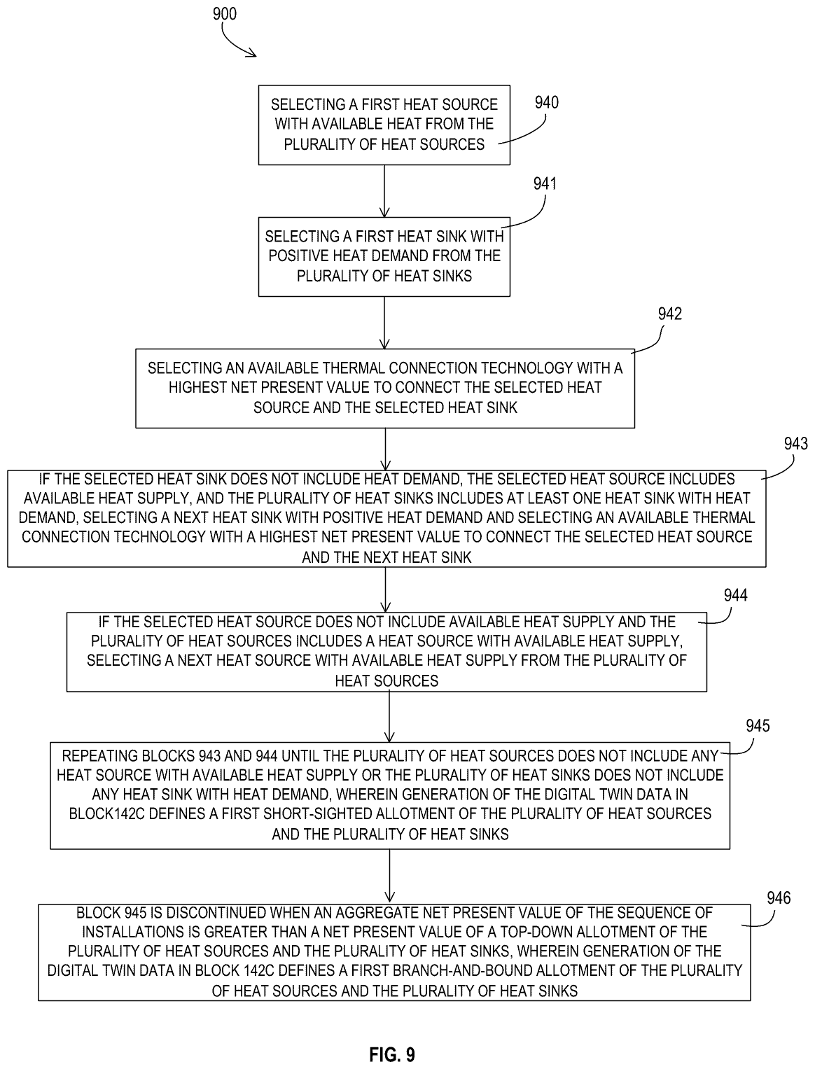

Turning to FIG. 9, a branch-and-bound allotment algorithm 900 may be implemented by a processor (e.g., processor 131a of FIG. 1A) executing, for example, at least a portion of the module 133a of FIG. 1A or, at least a portion of the modules 140b-146b of FIG. 1B. In particular, processor 131a may execute the approximate global optimum allotment determination module 144b to cause the processor 131a to, for example, selecting a first heat source with available heat from the plurality of heat sources (block 940).

The processor 131a may further execute the approximate global optimum allotment determination module 144b to cause the processor 131a to, for example, selecting a first heat sink with positive heat demand from the plurality of heat sinks (block 941). The processor 131a may further execute the approximate global optimum allotment determination module 144b to cause the processor 131a to, for example, selecting an available thermal connection technology with a highest net present value to connect the selected heat source and the selected heat sink (block 942).

The processor 131a may further execute the approximate global optimum allotment determination module 144b to cause the processor 131a to, for example, if the selected heat sink does not include heat demand, the selected heat source includes available heat supply, and the plurality of heat sinks includes at least one heat sink with heat demand, selecting a next heat sink with positive heat demand and selecting an available thermal connection technology with a highest net present value to connect the selected heat source and the next heat sink (block 943). The processor 131a may further execute the approximate global optimum allotment determination module 144b to cause the processor 131a to, for example, if the selected heat source does not include available heat supply and the plurality of heat sources includes a heat source with available heat supply, selecting a next heat source with available heat supply from the plurality of heat sources (block 944).

The processor 131a may further execute the approximate global optimum allotment determination module 144b to cause the processor 131a to, for example, repeating block 943 and block 942 until the plurality of heat sources does not include any heat source with available heat supply or the plurality of heat sinks does not include any heat sink with heat demand, wherein generation of the digital twin data in 142c defines a first short-sighted allotment of the plurality of heat sources and the plurality of heat sinks (block 945). The processor 131a may further execute the approximate global optimum allotment determination module 144b to cause the processor 131a to, for example, block 945 is discontinued when an aggregate net present value of the sequence of installations is greater than a net present value of a top-down allotment of the plurality of heat sources and the plurality of heat sinks, wherein generation of the digital twin data in block 142c defines a first branch-and-bound allotment of the plurality of heat sources and the plurality of heat sinks (block 946). A branch-and-bound algorithm 900 may explore all the possible branches but to cut them before they get top the end when they perform below a certain bound (e.g. top-down).

With reference to FIG. 10, a beam allotment algorithm 1000 may be implemented by a processor (e.g., processor 131a of FIG. 1A) executing, for example, at least a portion of the module 133a of FIG. 1A or, at least a portion of the modules 140b-146b of FIG. 1B. In particular, processor 131a may execute the approximate global optimum allotment determination module 144b to cause the processor 131a to, for example, determining an aggregate net present value of the first shortsighted allotment (block 1040).

The processor 131a may further execute the approximate global optimum allotment determination module 144b to cause the processor 131a to, for example, determining an aggregate net present value of the second shortsighted allotment (block 1041). The processor 131a may further execute the approximate global optimum allotment determination module 144b to cause the processor 131a to, for example, when the aggregate net present value of the first short-sighted allotment is greater than the aggregate net present value of the second short-sighted allotment, the aggregate net present value of the first short-sighted allotment defines a beam allotment of the plurality of heat sources and the plurality of heat sinks (block 1042).

The processor 131a may further execute the approximate global optimum allotment determination module 144b to cause the processor 131a to, for example, when the aggregate net present value of the second short-sighted allotment is greater than the aggregate net present value of the first short-sighted allotment, the aggregate net present value of the second short-sighted allotment defines the beam allotment of the plurality of heat sources and the plurality of heat sinks (block 1043).

The beam algorithm 1000 may select the top n shortsighted choices and to explore the performance of the following steps. Comparing the actual aggregate npv of the branches and selecting the candidate leading to the best aggregate npv helps internalize the opportunity cost of a choice. Hence, the choice is less short-sighted. Intuitively, this approach has a lot to do with the decision process of a chess-player. Note that for p→n, the runtime characteristics revert back to the initial O(n!) problem but for reasonable p (e.g. p<=5), the number of branches may be tractable.

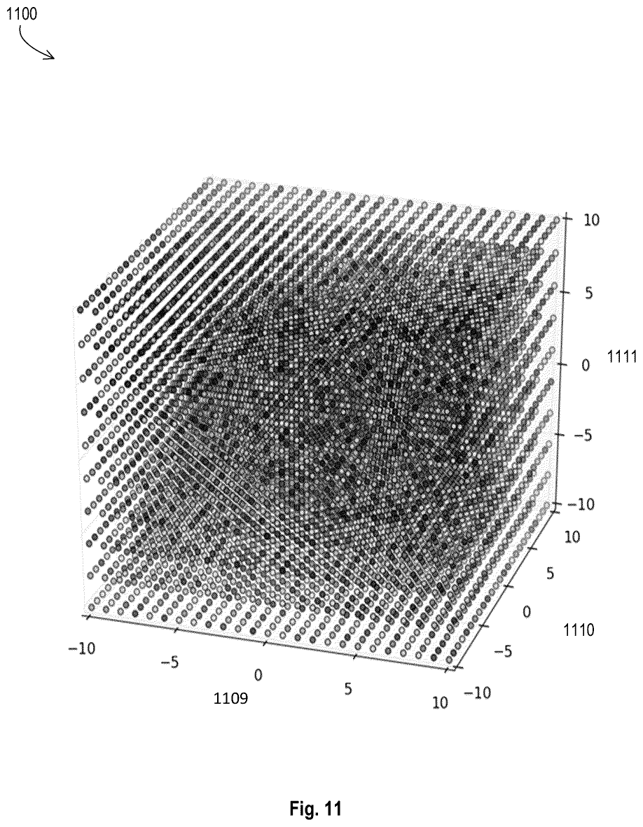

Turning to FIG. 11, a three-dimensional allotment data cube 1100 may include, for example, twin model data representative of every possible allotment of a plurality of heat sources 1109, a plurality of heat sinks 1110, and a plurality of thermal connections 1111.

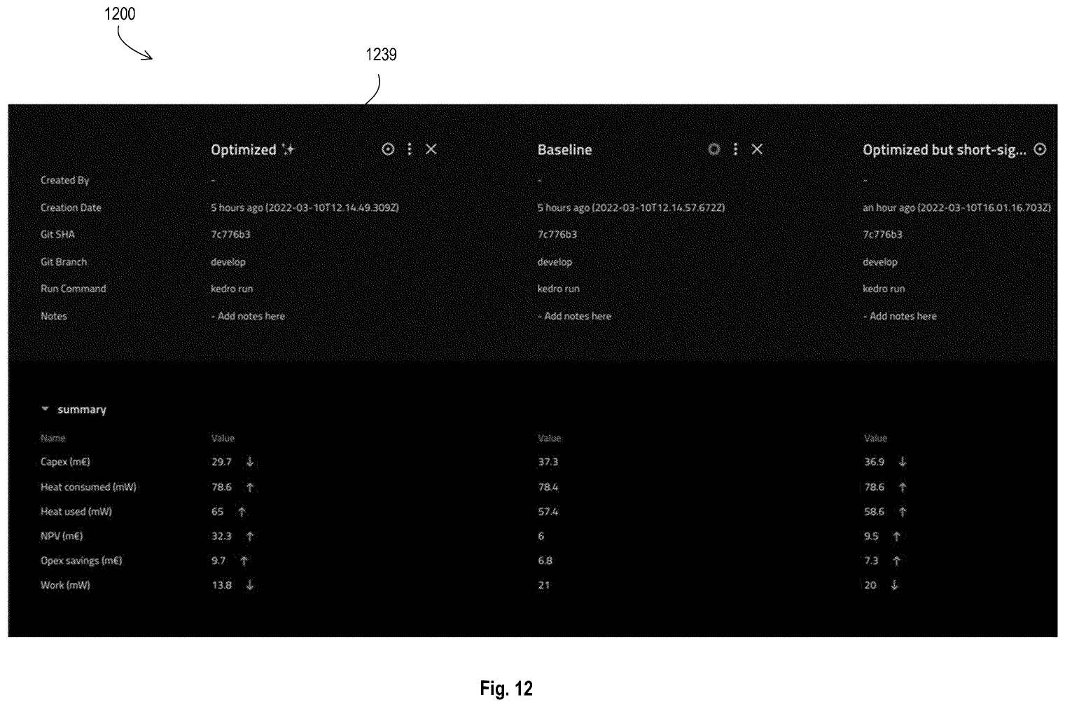

With reference to FIG. 12, an allotment summary display 1200 may include different allotments each having a sequence of installations, where each installation is defined by a technology, a source, a sink and its relative place in the allotment process. A baseline allotment may be useful to establish a comparison benchmark e.g. a current or projected client's steam recycling scheme. In some aspects, the baseline allotment must be defined in the data request file, specifically in the “baseline_allotment” worksheet. Once defined, the baseline allotment can be evaluated and scenarios compared. A comparison may be performed in response to, for example, a double click on best allotment. Each time the main pipeline is run or the evaluate-allotment pipeline, the allotment's summary (e.g., CapeX, NPV, OpeX savings, Heat used, Work, Heat consumed, etc.) is stored and available from the kedro-viz platform.

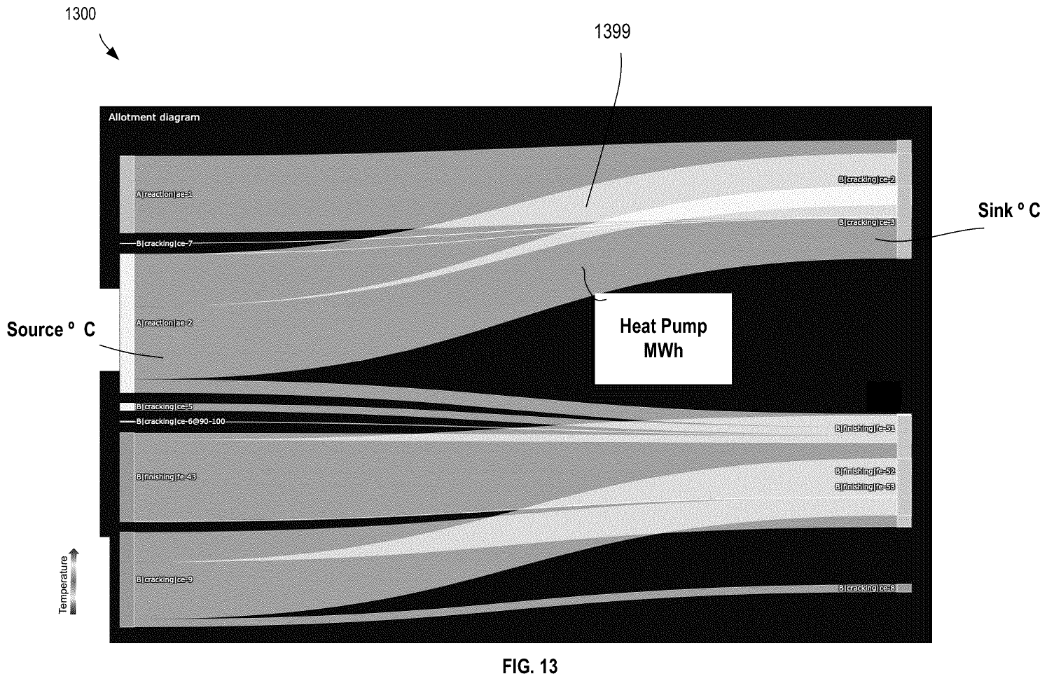

Turning to FIG. 13, a sankey diagram 1300 may indicate an optimized waste heat recovery 1339 including a heat pump of a number of megawatts connected between a source and having a temperature in Celsius a sink having a temperature in Celsius. The Sankey diagram allotment visualization 1300 may live as a standalone (e.g., python) command line interface.

Comparing scenarios front-end magic may happen behind the scenes. For example, a model may present a user-friendly visualization tool and integrated functionalities. In-depth analysis of the optimized heat recycling scheme and the algorithm may approximate the best sequence of heat recycling installation projects in a reasonable time. The underlying problem may be similar to a dynamic TSP, known to be highly computationally intensive.

### Additional Considerations

With the foregoing, users whose data is being collected and/or utilized may first opt-in. After a user provides affirmative consent, data may be collected from the user's device (e.g., a mobile computing device). In other embodiments, deployment and use of neural network models at a client or user device may have the benefit of removing any concerns of privacy or anonymity, by removing the need to send any personal or private data to a remote server.

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” or “an one aspect” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be con-figured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory product to which it is communicatively coupled. A further hardware module may then, at a later time, access the memory product to retrieve and process the stored output. Hardware modules may also initiate communications with input or output products, and can operate on a resource (e.g., a collection of information).

The various operations of example methods described herein may be performed, at least partial-ly, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a building environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a building environment, an office environment, or a server farm). In other example embodiments, the one or more processors or processor-implemented modules may be distributed across a number of geographic locations.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Upon reading this disclosure, those of skill in the art will appreciate still additional alternative structural and functional designs for the method and systems described herein through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

Moreover, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims. By way of example, and not limitation, the disclosure herein contemplates at least the following aspects:

1. A computer-implemented method for determining an approximate global optimum allotment of a plurality of devices to incorporate cold-to-hot thermal connection technologies within a plant, the method comprising: receiving, via one or more processors, device data including available heat sources, available thermal connections, and available heat sinks; processing, via one or more processors, the device data to generate a twin model corresponding to the devices; generating, via one or more processors, a sequence of simulated installations based on the twin model, to approximate the global optimum allotment of the plurality of devices with respect to a plant optimization target; and causing, via one or more processors, the approximate global optimum allotment to be stored in a non-transitory computer-readable memory.

2. The computer-implemented method of claim 1, wherein the device data includes template data corresponding to an audit of the plant, and wherein processing the device data to generate the twin model corresponding to the plant includes processing the template data.

3. The computer-implemented method of claim 1, wherein generating the sequence of simulated installations includes performing a top-down approximation algorithm.

4. The computer-implemented method of claim 1, wherein the plant optimization target is an aggregate net present value of the approximate global optimum allotment of the plurality of devices, wherein generating the sequence of simulated installations includes applying a domain knowledge-based heuristic including the steps of: identifying, in the simulated installations, a warmest heat source having a positive heat supply, a warmest heat sink having a positive heat demand and a first thermal connection having a maximum net present value with respect to the warmest heat source and the warmest heat sink; and generating an indication of the warmest heat source, the warmest heat sink and the first thermal connection.

5. The computer-implemented method of claim 4, further comprising: determining that the identified warmest heat sink lacks a positive heat demand and that the identified warmest heat source continues to have a positive heat supply; identifying, in the simulated installations, a second warmest heat source having a positive heat demand and a second thermal connection having a maximum net present value with respect to the second warmest heat source and the warmest heat sink; and generating an indication of the second warmest heat source, the warmest heat sink and the second thermal connection.

6. The computer-implemented method of claim 5, further comprising:
determining that the second warmest heat source lacks a positive heat supply; and identifying a third warmest heat source having positive heat supply.

7. The method of claim 6, further comprising: repeating one or more steps of claim 6 until one or both of (i) the simulated installations do not include any heat source having positive heat supply, and (ii) the simulated installations do not include any heat sink with positive heat demand.

8. The computer-implemented method of claim 4 or claim 5, further comprising: causing the warmest heat source and the warmest heat sink to be physically coupled according to the first thermal connection; and/or causing the second warmest heat source and the warmest heat sink to be physically coupled according to the second thermal connection.

9. The computer-implemented method of claim 1, further comprising: identifying, in the simulated installations, a heat source having a positive heat supply, a heat sink having a positive heat demand and a first thermal connection having a maximum net present value with respect to the heat source and the heat sink; in response to determining that the identified heat sink lacks a positive heat demand and that the identified heat source continues to have a positive heat supply, identifying, in the simulated installations, a second heat source having a positive heat demand and a second thermal connection having a maximum net present value with respect to the second heat source and the heat sink.

10. The computer-implemented method of claim 9, further comprising: repeating one or more steps of claim 9 until one or both of (i) the simulated installations do not include any heat source having positive heat supply, and (ii) the simulated installations do not include any heat sink with positive heat demand.

11. The computer-implemented method of claim 10, further comprising: in response to determining that an aggregate net present value of the sequence of installations is greater than a net present value of a top-down allotment, stopping the method, wherein the twin data is a first branch-and-bound allotment.

12. The method of claim 10, further comprising: identifying a third heat source having a positive heat supply, a second heat sink having positive heat demand and a second thermal connection having a maximum net present value with respect to the third heat source and the second heat sink; in response to determining that the second heat sink lacks a positive heat demand and that the third heat source includes a positive heat supply, identifying a third heat sink having positive heat demand and a third thermal connection technology having a maximum net present value with respect to the third heat source and the third heat sink; in response to determining that the third heat source does lacks a positive heat supply, identifying fourth heat source having a positive heat supply; and repeating the preceding steps until a heat source having positive heat supply cannot be identified and/or a heat sink having a positive heat demand cannot be identified, wherein the twin data is a second short-sighted allotment.

13. The method of claim 12, further comprising: in response to determining that an aggregate net present value of the sequence of installations is greater than a net present value of a top-down allotment, stopping the method, wherein the twin data is a second branch-and-bound allotment.

14. The method of claim 12, further comprising: determining an aggregate net present value of the first short-sighted allotment and an aggregate net present value of the second short-sighted allotment; determining a beam allotment based on the aggregate net present value of the first short-sighted allotment and the aggregate net present value of the second short-sighted allotment; and determining a second beam allotment based on the aggregate net present value of the second short-sighted allotment and the aggregate net present value of the first short-sighted allotment.

15. A computing system for determining an approximate global optimum allotment of a plurality of devices to incorporate cold-to-hot thermal connection technologies within a plant, comprising: one or more processors; and a memory comprising instructions that, when executed, cause the computing system to: receive, via one or more processors, device data including available heat sources, available thermal connections, and available heat sinks; process, via one or more processors, the device data to generate a twin model corresponding to the devices; generate, via one or more processors, a sequence of simulated installations based on the twin model, to approximate the global optimum allotment of the plurality of devices with respect to a plant optimization target; and cause, via one or more processors, the approximate global optimum allotment to be stored in a non-transitory computer-readable memory.

16. The computing system of claim 15, wherein generating the sequence of simulated installations includes performing at least one approximation algorithm selected from: a top-down approximation algorithm, a bottom-up approximation algorithm, a short-sighted approximation algorithm, a branch-and-bound approximation algorithm, or a beam approximation algorithm.

17. The computing system of claim 16, wherein further execution of the instructions further causes the computing system to: generate, via one or more processors, an allotment summary display, wherein the allotment summary display includes at least one output of a first one of the approximation algorithms juxtaposed with at least one correlative output of a second one of the approximation algorithms, wherein the at least one output is selected from: a capital expenditure, a net present value, an operational cost savings, heat used, work, or heat consumes.

18. A non-transitory computer-readable storage medium comprising executable instructions that, when executed by a processor, cause a computer to: receive, via one or more processors, device data including available heat sources, available thermal connections, and available heat sinks; process, via one or more processors, the device data to generate a twin model corresponding to the devices; generate, via one or more processors, a sequence of simulated installations based on the twin model, to approximate the global optimum allotment of the plurality of devices with respect to a plant optimization target; and cause, via one or more processors, the approximate global optimum allotment to be stored in a non-transitory computer-readable memory.

19. The non-transitory computer-readable storage medium of claim 18, wherein generating the sequence of simulated installations includes performing at least one approximation algorithm selected from: a top-down approximation algorithm, a bottom-up approximation algorithm, a short-sighted approximation algorithm, a branch-and-bound approximation algorithm, or a beam approximation algorithm.

20. The computer-readable medium of claim 18, wherein generating the sequence of simulated installations includes applying a domain knowledge-based heuristic including the steps of: identifying, in the simulated installations, a warmest heat source having a positive heat supply, a warmest heat sink having a positive heat demand and a cold-to-hot thermal connection having a maximum net present value with respect to the warmest heat source and the warmest heat sink; and generating an indication of the warmest heat source, the warmest heat sink and the cold-to-hot thermal connection.

Thus, many modifications and variations may be made in the techniques, methods, and structures described and illustrated herein without departing from the spirit and scope of the present claims. Accordingly, it should be understood that the methods and apparatus described herein are illustrative only and are not limiting upon the scope of the claims.

1. A computer-implemented method for determining an approximate global optimum allotment of a plurality of devices to incorporate cold-to-hot thermal connection technologies within a plant, the method comprising:
receiving, via one or more processors, device data including available heat sources, available thermal connections, and available heat sinks;
processing, via one or more processors, the device data to generate a twin model corresponding to the devices;
generating, via one or more processors, a sequence of simulated installations based on the twin model, to approximate the global optimum allotment of the plurality of devices with respect to a plant optimization target; and
causing, via one or more processors, the approximate global optimum allotment to be stored in a non-transitory computer-readable memory.

2. The computer-implemented method of claim 1,
wherein the device data includes template data corresponding to an audit of the plant, and
wherein processing the device data to generate the twin model corresponding to the plant includes processing the template data.

3. The computer-implemented method of claim 1,
wherein generating the sequence of simulated installations includes performing a top-down approximation algorithm.

4. The computer-implemented method of claim 1, wherein the plant optimization target is an aggregate net present value of the approximate global optimum allotment of the plurality of devices, wherein generating the sequence of simulated installations includes applying a domain knowledge-based heuristic including the steps of:
identifying, in the simulated installations, a warmest heat source having a positive heat supply, a warmest heat sink having a positive heat demand and a first thermal connection having a maximum net present value with respect to the warmest heat source and the warmest heat sink; and
generating an indication of the warmest heat source, the warmest heat sink and the first thermal connection.

5. The computer-implemented method of claim 4, further comprising:
determining that the identified warmest heat sink lacks a positive heat demand and that the identified warmest heat source continues to have a positive heat supply;
identifying, in the simulated installations, a second warmest heat source having a positive heat demand and a second thermal connection having a maximum net present value with respect to the second warmest heat source and the warmest heat sink; and
generating an indication of the second warmest heat source, the warmest heat sink and the second thermal connection.

6. The computer-implemented method of claim 5, further comprising:
determining that the second warmest heat source lacks a positive heat supply; and
identifying a third warmest heat source having positive heat supply.

7. The method of claim 6, further comprising:
repeating one or more steps of claim 6 until one or both of (i) the simulated installations do not include any heat source having positive heat supply, and (ii) the simulated installations do not include any heat sink with positive heat demand.

8. The computer-implemented method of claim 4, further comprising:
causing the warmest heat source and the warmest heat sink to be physically coupled according to the first thermal connection; and/or
causing the second warmest heat source and the warmest heat sink to be physically coupled according to the second thermal connection.

9. The computer-implemented method of claim 1, further comprising:
identifying, in the simulated installations, a heat source having a positive heat supply, a heat sink having a positive heat demand and a first thermal connection having a maximum net present value with respect to the heat source and the heat sink;
in response to determining that the identified heat sink lacks a positive heat demand and that the identified heat source continues to have a positive heat supply, identifying, in the simulated installations, a second heat source having a positive heat demand and a second thermal connection having a maximum net present value with respect to the second heat source and the heat sink.

10. The computer-implemented method of claim 9, further comprising:
repeating one or more steps of claim 9 until one or both of (i) the simulated installations do not include any heat source having positive heat supply, and (ii) the simulated installations do not include any heat sink with positive heat demand.

11. The computer-implemented method of claim 10, further comprising:
in response to determining that an aggregate net present value of the sequence of installations is greater than a net present value of a top-down allotment, stopping the method,
wherein the twin data is a first branch-and-bound allotment.

12. The method of claim 10, further comprising:
identifying a third heat source having a positive heat supply, a second heat sink having positive heat demand and a second thermal connection having a maximum net present value with respect to the third heat source and the second heat sink;
in response to determining that the second heat sink lacks a positive heat demand and that the third heat source includes a positive heat supply, identifying a third heat sink having positive heat demand and a third thermal connection technology having a maximum net present value with respect to the third heat source and the third heat sink;
in response to determining that the third heat source does lacks a positive heat supply, identifying fourth heat source having a positive heat supply; and
repeating the preceding steps until a heat source having positive heat supply cannot be identified and/or a heat sink having a positive heat demand cannot be identified,
wherein the twin data is a second short-sighted allotment.

13. The method of claim 12, further comprising:
in response to determining that an aggregate net present value of the sequence of installations is greater than a net present value of a top-down allotment, stopping the method,
wherein the twin data is a second branch-and-bound allotment.

14. The method of claim 12, further comprising:
determining an aggregate net present value of the first short-sighted allotment and an aggregate net present value of the second short-sighted allotment;
determining a beam allotment based on the aggregate net present value of the first short-sighted allotment and the aggregate net present value of the second short-sighted allotment; and
determining a second beam allotment based on the aggregate net present value of the second short-sighted allotment and the aggregate net present value of the first short-sighted allotment.

15. A computing system for determining an approximate global optimum allotment of a plurality of devices to incorporate cold-to-hot thermal connection technologies within a plant, comprising:
one or more processors; and
a memory comprising instructions that, when executed, cause the computing system to:
receive, via one or more processors, device data including available heat sources, available thermal connections, and available heat sinks;
process, via one or more processors, the device data to generate a twin model corresponding to the devices;
generate, via one or more processors, a sequence of simulated installations based on the twin model, to approximate the global optimum allotment of the plurality of devices with respect to a plant optimization target; and
cause, via one or more processors, the approximate global optimum allotment to be stored in a non-transitory computer-readable memory.

16. The computing system of claim 15,
wherein generating the sequence of simulated installations includes performing at least one approximation algorithm selected from: a top-down approximation algorithm, a bottom-up approximation algorithm, a short-sighted approximation algorithm, a branch-and-bound approximation algorithm, or a beam approximation algorithm.

17. The computing system of claim 16, wherein further execution of the instructions further causes the computing system to:
generate, via one or more processors, an allotment summary display, wherein the allotment summary display includes at least one output of a first one of the approximation algorithms juxtaposed with at least one correlative output of a second one of the approximation algorithms, wherein the at least one output is selected from: a capital expenditure, a net present value, an operational cost savings, heat used, work, or heat consumes.

18. A non-transitory computer-readable storage medium comprising executable instructions that, when executed by a processor, cause a computer to:
receive, via one or more processors, device data including available heat sources, available thermal connections, and available heat sinks;
process, via one or more processors, the device data to generate a twin model corresponding to the devices;
generate, via one or more processors, a sequence of simulated installations based on the twin model, to approximate the global optimum allotment of the plurality of devices with respect to a plant optimization target; and
cause, via one or more processors, the approximate global optimum allotment to be stored in a non-transitory computer-readable memory.

19. The non-transitory computer-readable storage medium of claim 18,
wherein generating the sequence of simulated installations includes performing at least one approximation algorithm selected from: a top-down approximation algorithm, a bottom-up approximation algorithm, a short-sighted approximation algorithm, a branch-and-bound approximation algorithm, or a beam approximation algorithm.

20. The computer-readable medium of claim 18, wherein generating the sequence of simulated installations includes applying a domain knowledge-based heuristic including the steps of:
identifying, in the simulated installations, a warmest heat source having a positive heat supply, a warmest heat sink having a positive heat demand and a cold-to-hot thermal connection having a maximum net present value with respect to the warmest heat source and the warmest heat sink; and
generating an indication of the warmest heat source, the warmest heat sink and the cold-to-hot thermal connection.
